(19) United States
(12) Patent Application Publication
(10) Pub. No.: US 2014/0132729 A1
(43) Pub. Date: May 15, 2014

(54) METHOD AND APPARATUS FOR CAMERA-BASED 3D FLAW TRACKING SYSTEM

(71) Applicant: CYBERNET SYSTEMS CORPORATION, Ann Arbor, MI (US)

(72) Inventors: Eugene Foulk, Ann Arbor, MI (US); Kevin Tang, Ann Arbor, MI (US); Glenn J. Beach, Grass Lake, MI (US)

(73) Assignee: CYBERNET SYSTEMS CORPORATION, Ann Arbor, MI (US)

(21) Appl. No.: 14/081,367

(22) Filed: Nov. 15, 2013

Related U.S. Application Data
(60) Provisional application No. 61/726,942, filed on Nov. 15, 2012.

(51) Int. Cl. G01N 21/88; G06T 7/00; G06F 17/50; H04N 13/02

(52) U.S. Cl. CPC G01N 21/8806; H04N 13/0221; G06T 7/0004; G06F 17/50
USPC 348/46; 382/103

(57) ABSTRACT

Systems and methods facilitate long-range, accurate fiducial tracking using a mixture of pan-tilt and camera devices enabling generalized 3D tracking of fiducials with the automatic mapping of flaw data to component models within standard CAD packages. The invention is suitable to many various tracking applications, particularly large inspection sites such as aircraft surfaces which require vast coverage with a medium-degree of accuracy. A method of surface inspection comprises the steps of moving a fiducial target over a surface under inspection, and tracking the fiducial as it is moved by capturing and storing the coordinates of the fiducial in a database for subsequent retrieval. Machine vision is used to acquire surface inspection data associated with the coordinates of the fiducial as it is moved. The inspection data is integrated into a CAD model, enabling the use of finite element analysis (FEA) to determine or predict flaw and material behavior over time.

### REFERENCE TO RELATED APPLICATION

This application claims priority from U.S. Provisional Patent Application Ser. No. 61/726,942, filed Nov. 15, 2012, the entire content of which is incorporated herein by reference.

### FIELD OF INVENTION

The present invention relates generally to systems and methods for tracking and mapping of flaws, and more particularly to systems and methods for long-range, accurate fiducial tracking using a mixture of pan-tilt and camera devices.

### BACKGROUND OF THE INVENTION

It is sometimes necessary to precisely measure large structures to verify dimensions and, in some case, precisely locate flaws. Many alternative means for accomplishing this include using laser range finding [Ohtomo et al., Ohishi et al., Kumagi et al., Medina, and SICK], theodolite survey equipment [Gotoh, Benz et al., Leica], laser triangulation [Ura, Kaneko, Sasaki et al., Bosch], autofocus controls [Tsuda et al.] and 3D computer vision (which uses relative object sizes, stereopsis, or alternative feature detection and size computation.

U.S. Pat. No. 7,633,609 describes a surveying instrument for projecting a laser beam by rotary irradiation and a photodetection sensor device installed at a measuring point. Communication is performed between the surveying instrument and the photodetection sensor device, wherein the surveying instrument comprises an angle detecting means for detecting a horizontal angle in a projecting direction of the laser beam and a first arithmetic unit for controlling the angle detecting means based on a receiving signal from the first radio communication unit. The photodetection sensor device comprises a photodetection unit for receiving the laser beam and a second arithmetic unit for performing transmission of a photodetection notifying signal to notify the receiving of the laser beam by the photodetection unit and also for performing transmission of a synchronization data by the second radio communication unit to the first radio communication unit, wherein the first arithmetic unit calculates a horizontal angle of the projection of the laser beam when the photodetection sensor device receives the laser beam based on the photodetection notifying signal and the synchronization data.

Another surveying system, described in U.S. Pat. No. 6,907,133, includes a telescopic optical system and an image pickup device for picking up an image of a graduated face of a level rod to which the telescopic optical system is to be collimated. A memory stores recognition data of at least one of a pattern, numbers, and scale calibrations, provided on the graduated face of the level rod. An analyzing device for analyzing and recognizing the picked-up image of the at least one of the pattern, numbers, and scale calibrations of the level rod, based on the image data of the level rod picked up by the image pickup device and the recognition data of the pattern, numbers, and scale calibrations, read from the memory, to obtain a measurement.

U.S. Pat. No. 7,196,795 discloses laser measurement apparatus. Optical signal processing units output laser beams having different wavelengths via a common optical path toward an object to be measured. The laser beams are reflected by a corner cube attached to the object to be measured. A control unit controls motors so that the laser beams return to a predetermined position of an optical position sensing device of an optical signal processing unit according to which the direction of a reflecting mirror is controlled so that the laser beams follow the object. The control unit computes the distance to the object, or the shape, position, speed etc. of the object based on signals detected at the optical signal processing units.

A surveying instrument is described in U.S. Pat. No. 5,923,468 having a sighting telescope and a distance measuring device. The sighting telescope has a focusing lens group which is moveable to focus an object to be measured. The distance measuring device measures a distance between the object and the surveying instrument. A focusing operation of the sighting telescope is carried out to move the focusing lens group to a focal position of the object in accordance with the distance between the object and the surveying instrument measured by the distance measuring device.

### SUMMARY OF THE INVENTION

This invention resides in systems and methods for long-range, accurate fiducial tracking using a mixture of pan-tilt and camera devices. The approach enables generalized 3D tracking of fiducials with the automatic mapping of flaw data to component models within standard CAD packages. The methods and apparatus of the invention are suitable for many various tracking applications, and particularly well-suited to large inspection sites which require vast coverage with a medium-degree of accuracy.

A method of surface inspection according to the invention comprises the steps of moving a fiducial target over a surface under inspection, and tracking the fiducial as it is moved by capturing and storing the coordinates of the fiducial in a database for subsequent retrieval. Machine vision is used to acquire surface inspection data associated with the coordinates of the fiducial as it is moved. The inspection data is integrated into a CAD model, enabling the use of finite element analysis (FEA) to determine or predict flaw and material behavior over time. The fiducial is preferably a cube with computer-readable codes such as a zxing bar code cube. The surface forms part of an aircraft.

### BRIEF DESCRIPTION OF THE DRAWINGS

FIG. 1 depicts hardware components associated with a preferred embodiment of the invention;

FIG. 2 illustrates of the tracker components;

FIG. 3 is a simplified drawing of a non-destructive examination (NDE) inspection unit;

FIG. 4 is a system block diagram; and

FIG. 5 shows Zxing barcodes.

### DETAILED DESCRIPTION OF THE INVENTION

The present invention is directed to methods and apparatus for generalized 3D tracking of fiducials with the automatic mapping of flaw data to component models within standard CAD packages. The methods and apparatus of the invention are suitable for many various tracking applications, and particularly well-suited to large inspection sites which require vast coverage with a medium-degree of accuracy. The system provides at least the following capabilities:
1. Automatically tracks a fiducial attached to a sensor with minimal requirements from the user;
2. Maps the location data and associated sensor data into a computer-aided design (CAD) model;
3. Automatically calibrates itself;
4. Gives quarter-inch accuracy 3D position & pose; and
5. Puts the location and sensor data into a database;

A primary goal of the system it to repeatably re-find flaws over the surface of a large object like an aircraft in multiple measurement sessions, perhaps spaced in time by months or even years, to track detected defects as they evolve over time. This is accomplished by placing a fiducial (which may be composed of a zxing barcode cube—bar codes on a 6 faced cubic object) on a flaw measurement sensor. As this sensor is swept over the surface under inspection, its location is continuously tracked so that the position of each sensor data set captured and stored in a database is precisely located and this location coordinate can later be used to re-find any defect again in subsequent inspections.

The invention uses machine vision to localize fiducial location data gathered during inspection. Experts can then integrate inspection data into the CAD models, allowing finite element analysis tools to help predict flaw and material behavior.

Many inspection processes are slow, tedious, and costly. This invention focuses on increasing the speed at which these inspections can be performed, particularly on large structures.

The applications for the invention include:

Tracking sensor positions—As a sensor with fiducial attached is moved and captures data, it is tracked and its location captured precisely;

Dynamic coverage mapping—Supports determination that a specified area is inspected completely;

Inspection scan guidance—Can be used to prompt an inspector or mechanism (say a robotically controlled boom) to where to re-inspect the surface over where previously flaws have been detected;

Long-term trend analysis of flaw data—By multiple re-inspection, flaw evolution can be tracked over time;

Metrology and measuring large objects—As is done in surveying or theodolite measurement, this instrument can automatically take accurate measurements of locations over large volumes;

Generating models of the target with point clouds—3D models or large objects can be made in CAD systems accurately from measurement points taken through the instrument described;

Ensuring users or robots stay out of areas—By tracking the location of any object of person in a controlled area, this location data can be used determine if the entity is in a denied area and appropriate action taken;

Performance measurements of how efficiently fiducials are moving—By examining the location tracks made by a moving object, attributes of motion can be associated with other parameters, like efficiency;

Tracking measurements across time and correlating them to the same place;

Inspection of large structures on aging aircraft;

Inspection of large structures on spacecraft;

Inspection of large boats and ships, ground vehicles, and helicopter systems; and

Inspection of military and commercial vehicles or structures.

The system uses tripod-located multiple resolution cameras that exploit the range and orientation computational capability of constructed barcodes. The driving requirements for all of these long range measurement systems are precise pitch and yaw axis angle measurement and accurate range measurement. The approach uses multiple mutually calibrated fixed focal length cameras to detect the zxing family of bar codes, first a low-resolution version to detect the code and approximately locate it over a wide field, then to slew a precision pan-tilt mechanism to center the code in the field of view of high resolution telephoto camera. The high resolution version can then be precisely located for a precision measurement of the range and orientation relative to the camera.

Existing camera-based tracking systems tend to trade off range and accuracy: the longer/shorter the tracking distance, the lower/higher the accuracy. Additionally, the narrow field-of-view necessary for high-accuracy XYZ position tracking dictates frequent repositioning of the tracking apparatus in order to track fiducials across large areas.

This invention is suited to large-scale inspection applications, where techniques for keeping track of flaws and their location and evolution of these flaws over time requires precise measurement of large volumes. The goals is to locate repeatably flaw points over a large working area of over 200 square feet and a height of more than 100 feet to better than ¼″ requires a system that can both make measurements over a large volume and also to a very high degree of precision (approximately one part per 1000 or better). Current flaw mapping and inspection approaches are haphazard, imprecise, inspection-specific, and not easily generalized.

### Method of Operation

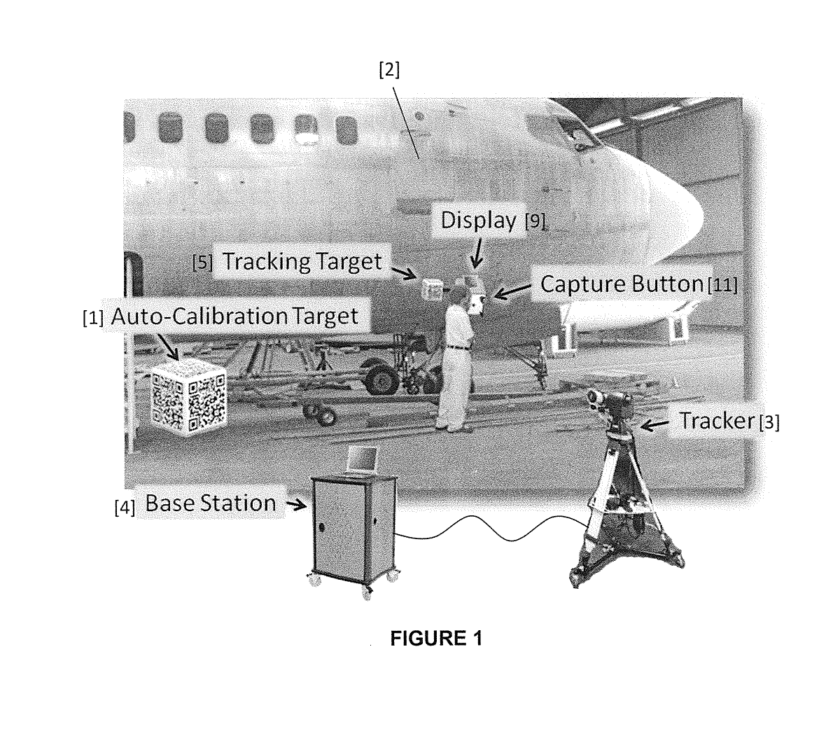

Making reference now to FIG. 1, the tracker [3] registers its location and pose with respect to an auto-calibration target [1]. An auto-calibration target [1] is a bar-coded cube which is placed in a standard position relative to the object [2] to be measured—in FIG. 1 this is an aircraft fuselage. The tracking system [3] controlled by a controller [4] first scans the environment for the auto-calibration target [1], and then determines the location of the auto-calibration target fiducial using image registration (zxing bar code identification and position/orientation determination—shown in FIG. 5). This allows the tracker system to register the coordinate system measured relative to tracker tripod position to the object centered coordinate system (which is typically how defects found in the object will be located).

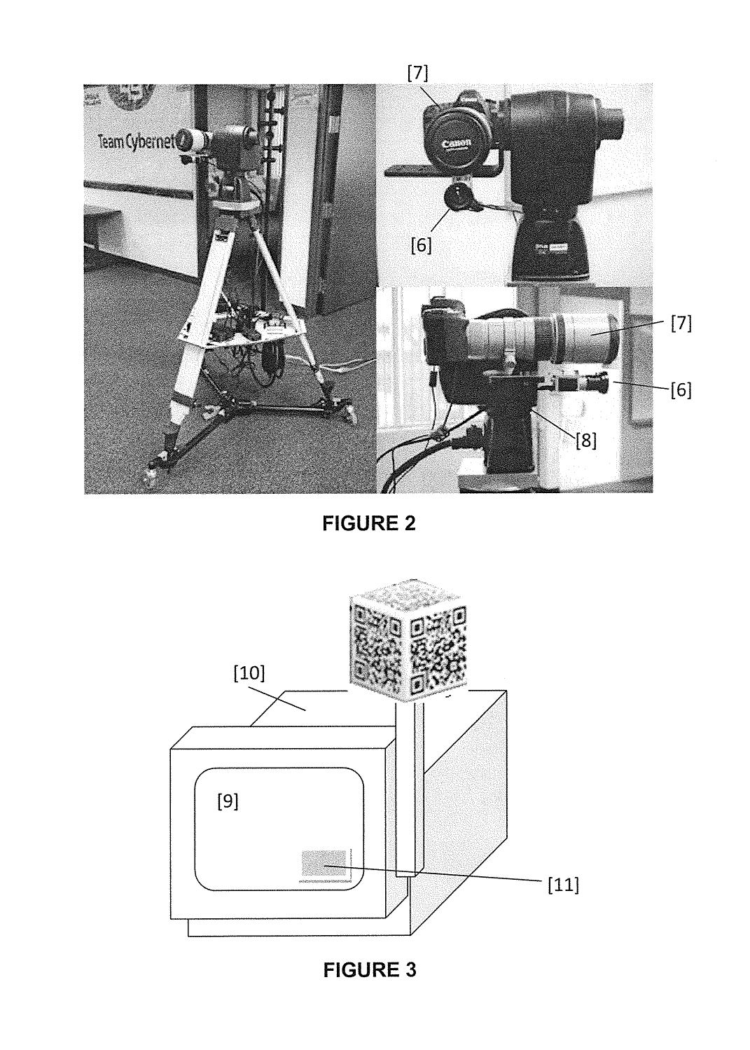

Then the tracker identifies the tracking target [5] located on the inspection device and continuously tracks the tracking target to register the location of the inspection device. Referring to the tracker head shown in FIG. 2, the process of identification is done through a wide field camera [6] that identifies the tracking target, validates its code, and performs imprecise code location. Then the system slews the tracking head to the target location so that the high resolution camera [7] can capture and locate the target to the required precision.

The pan-tilt head [8] primarily provide highly precise positioning of the high resolution telephoto camera [7] so that the target barcode can be located in a significant portion of the camera field of view (for more accurate measurement derived from the barcode location determination algorithm). It also significantly reduces the repositioning and re-registering of the tracker in order to cover large areas. The pan-tilt also enables faster location registration by automatically finding and slewing the tracker to fix the cameras on the auto-calibration target, and then applying a transform of the pan-tilt degree angles to automatically determine the 3D pose and XYZ position location of the tracker with respect to the auto-calibration target.

The wide-angle camera [6] assists in tracking the movement of the tracking target, while the high-resolution camera captures high-resolution images to register the target's location to a higher accuracy. The high-resolution camera increases the range of the tracker and its working envelope. The high-resolution accuracy also enables target object registration without the existence of a CAD model when the auto-calibration target is placed at consistent locations in the environment. This allows the registration of tracking data to be done during different scanning sessions. Finally, this tracking data consisting of the position and 3D pose can then be mapped to any available CAD model.

The following summarizes important hardware components of the system:

Auto-Calibration Target [1]: This fiducial will be used by the tracker to determine the location of the tracker. This fiducial may be a passive or active tag but the method shown in FIG. 1 uses a passive barcode target cube. The tag is uniquely identifiable through the barcode code, enabling the tracking of different tracking targets in the same scene. The auto-calibration target may be affixed to a three-dimensional object of known dimensions (like a push cart or fixture that is used to place it at a know spot relative to the object being measured [2]), or affixed to a target object being inspected. The auto-calibration target will be placed at known location in the environment so that future tracking sessions will be consistent from measurement session to the next.

Tracking Target [5]: This fiducial is attached to the inspection device at a known offset. This fiducial may be a passive or active tag but the method shown in FIG. 1 uses a smaller passive barcode target cube. The tag is uniquely identifiable, enabling the tracking of different tracking targets in the same scene. The tracking target is tracked by the tracker [3].

Display [9]: This display shown in FIG. 3 is attached to the inspection device being tracked [10]. This is a touch-screen capable display whose purpose is to guide the inspection. It displays the coverage map of locations already scanned, relays session data, and allows the user to identify flaws in the scan.

Capture Button [11]: This button is attached to the inspection device, and signals the tracker to capture the current position of the tracking target. This button also serves as a lighted indicator to inform the operator when the tracking target is acquired by the tracker.

Base Station [4]: This computer that controls the overall system; displays live feeds from the inspection device and the tracker; updates an overall view of the scene including the target object being inspected; and provides access to other scan session information. The base station sends the tracker control commands and receives imaging data for registering the tracker's position and orientation with respect to the auto-calibration and tracking targets.

Tracker [3]: The tracker is primarily composed of two cameras and a pan-tilt unit (see FIG. 2). The tracker consists of 1) a high-resolution and high-magnification camera [7], and 2) a wide-angle camera [6], both attached to 3) a pan-tilt unit [8]. These are mounted on 4) a tripod that includes, 5) a tripod dolly with brake-equipped wheels.

The NDE inspection unit [12], depicted in FIG. 3, represents the integrated tracking target, inspection device, capture button, and display that the operator uses.

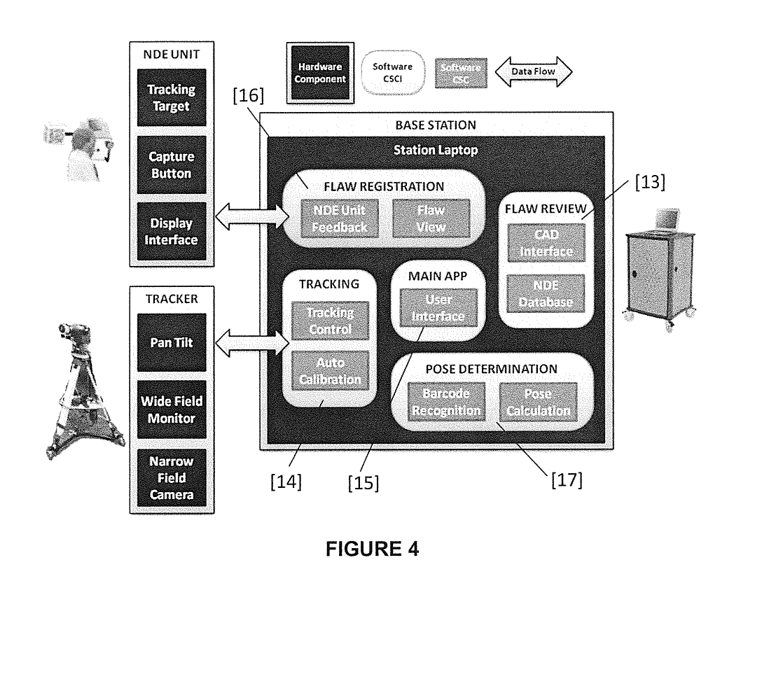

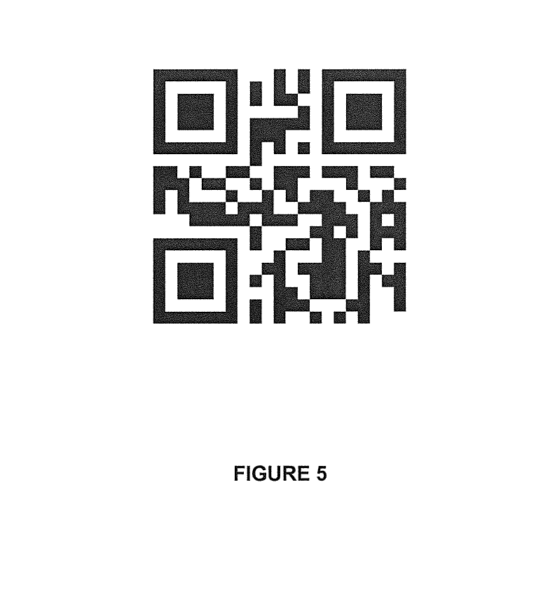

FIG. 4 shows the overall system diagram. Software components are shown inside of the base station and the following summarizes the software components of the system. The system is designed such that modules and alternate flaw definition modalities can be easily incorporated.

Flaw Review CSCI [13]: Responsible for providing an interface for reviewing flaw data.

NDE Database CSC: Stores and retrieves the data associated with a target object location or flaw. This enables inspection experts to later view and manipulate the data in the context of a 3D CAD model of the inspected object.

CAD Interface CSC: Initializes and executes the third-party CAD application functions for the 3D mapping capabilities. The flaw locations and their severity will be represented by 3D markers and artifacts with annotations capable of being hyperlinked so that the data can be called up from the NDE database to a standard web page. The 3D markers and artifacts can be programmatically added to the CAD model through the use of macros. The macros will be designed to load in the 3D coordinates and annotation data from a file, and output the flaw markers for viewing in the standard CAD package.

Tracking CSCI [14]: Responsible for controlling the pan-tilt to track the targets.

Tracking Control CSC: Controls the wide-angle and high-resolution cameras to track the target tags.

Auto Calibration CSC: Calibrating the tracker to the auto-calibration target.

Main App CSCI [15]: Manages the execution of the overall system.

User Interface CSC: Provides a user interface for the Base Station.

Flaw Registration CSCI [16]: Relays feedback and data to and from the NDE Unit

NDE Unit Feedback CSC: Provides feedback from the NDE Unit

Flaw View CSC: Updates the live flaw view during the scan session.

Pose Determination CSCI [17]: Determining the position and orientation of the tracking target.

Barcode Recognition CSC: Identifies the tracking target in the scene

Pose Calculation CSC: Calculates the position and orientation of the tracking target.

1. A method of surface inspection, comprising the steps of:
moving a fiducial target over a surface under inspection;
tracking the fiducial as it is moved by capturing and storing the coordinates of the fiducial in a database for subsequent retrieval;
using machine vision to acquire surface inspection data associated with the coordinates of the fiducial as it is moved;
integrating the inspection data into a CAD model; and
performing a finite element analysis (FEA) on the surface inspection data to determine surface or material characteristics.

2. The method of claim 1, wherein the fiducial is a cube with computer-readable codes.

3. The method of claim 1, wherein the fiducial is a zxing bar code cube.

4. The method of claim 1, wherein the surface forms part of an aircraft.

5. The method of claim 1, including the step of determining the location of the fiducial using image registration.

6. The method of claim 1, including the steps of:
using a wide-field camera to identify the fiducial; and
using a high resolution camera can capture and locate the target to a desired degree of precision.

7. The method of claim 1, including the step of mapping the position and 3D pose to the CAD model.

8. The method of claim 1, including the step of performing multiple inspection processes to determine or predict flaw and material behavior over time.

9. A method of localizing fiducials in 3D space, comprising the steps of:
placing an auto-calibration fiducial target encoding fiducial data in a real environment;
placing at least one other fiducial in the environment to be tracked;
providing a pan-tilt apparatus composed of a wide-field of view camera and a high resolution, high magnification, narrow field-of-view camera;
acquiring an image of the environment and detecting the fiducial target with the wide-field camera;
slewing the pan-tilt apparatus to fix the narrow field-of-view camera to capture an image of the fiducial target;
estimating the 3D pose and location of the fiducial target;
auto-localizing the pan-tilt apparatus based on the fiducial target;
mapping the fiducial data to a CAD model, thereby enabling finite element analysis tools to predict flaw and material behavior; and
associating prior acquired data with respect to the fiducial placed in the environment.

10. The method of claim 9, wherein the auto-calibration fiducial target is in the form of a three-dimensional computer-readable code.

11. The method of claim 9, wherein the auto-calibration fiducial target is automatically found and registered.

12. A camera-based 3D mapping system using the location and pose of a fiducial target in an environment, comprising:
a wide-angle imager for locating the fiducial;
a high-resolution, high-magnification imager for extracting details from the fiducial;
pan-tilt apparatus to adjust the fields of view of the cameras;
a processor for automatically determining the 3D pose and location of the fiducial and for automatically mapping the fiducial data to a CAD model; and
a memory for storing prior acquired data with respect to the fiducial placed in the same location, enabling comparisons to be made between the fiducial data and the prior acquired data.

13. The camera-based 3D mapping system of claim 12, wherein the wide-angle imager is a wide-angle camera monitoring live video.

14. The camera-based 3D mapping system of claim 12, wherein the high-resolution, high-magnification imager is a camera monitoring live video.
